(19) United States
(12) Patent Application Publication
(10) Pub. No.: US 2022/0383349 A1
(43) Pub. Date: Dec. 1, 2022

(54) SYSTEM AND METHOD FOR PARTITIONING GEOGRAPHICAL AREAS INTO LOGISTICAL AREAS FOR DYNAMIC PRICING

(71) Applicant: GRABTAXI HOLDINGS PTE. LTD., Singapore (SG)

(72) Inventors: Weili YAN, Singapore (SG); Wentong LI, Singapore (SG); Chen WANG, Singapore (SG)

(21) Appl. No.: 17/619,940

(22) PCT Filed: Feb. 18, 2020
(86) PCT No.: PCT/SG2020/050081

§ 371 Date: Dec. 16, 2021

(51) Int. Cl. G06Q 30/02; G06K 9/62; G06F 16/28; G06F 16/29

(52) U.S. Cl. CPC G06Q 30/0205; G06Q 30/0206; G06Q 30/0284; G06K 9/6218; G06F 16/285; G06F 16/29

(57) ABSTRACT

A method for partitioning a geographic area, including: partitioning the geographic area into geographic units; for each respective geographic unit: determining, a central location of the respective geographic unit; determining, an aggregate demand location of the respective geographic unit based on pick-up locations in the respective geographic unit in a time period; determining, an aggregate supply location of the respective geographic unit based on provider locations when responding to requests having pick-up locations in the respective geographic unit in said time period; for each respective pair of geographic units, determining, among a plurality of the geographic units, a connection strength between the respective pair based on distance metrics between the respective pair, where the distance metrics are determined based on the central locations, the aggregate supply locations, and the aggregate demand locations of the respective pair in said time period; and assigning each respective geographic unit to a respective one of one or more aggregate geographic units based on the determined connection strengths.

### TECHNICAL FIELD

Various aspects of this disclosure generally relate to partitioning a geographic area, and more particularly, to partitioning a geographic area into one or more logistical geographic sub-areas for determining dynamic pricing.

### BACKGROUND

Ride-hailing services requested through mobile devices have grown in popularity. At certain times of the day there is much more demand (i.e., hailers or passengers) than there is supply (i.e., drivers or providers). In response to the imbalance between supply and demand, dynamic pricing (e.g., Uber's “surge” pricing) was introduced to minimize the gap. Presently, dynamic pricing is often determined by partitioning areas of a city into a grid of predefined geocoded cells (e.g., geohash, geohex, google s2, etc.) and assigning a pricing multiplier (weighted factor) to each geocoded cell. Typically, the pricing multiplier is computed based on supply and demand data of each individual geocoded cell or unit. The use of predefined geocoded cells is straightforward and computationally efficient but not ideal as the relationship between the supply and demand of each geocoded cell are not taken into consideration. For example, if two POIs (points of interest, usually pick up and drop off points on map) associated with the same building arbitrarily falls into two different geocoded cells (grid units on map), the price multipliers are computed separately using their respective own supply and demand data. In some cases, this might result in significant different price multiplier values even though the two POIs may have the same supply pool and demand pattern. Consequently, some passengers experience a dynamic pricing difference over 50% during one booking session which is largely due to the limitation of using predefined geocoded cells for calculating dynamic pricing. Accordingly, it is desirable to have an efficient process to identify common supply and demand patterns, so that if two POIs share a similar demand and supply pattern, dynamic pricing computation should be conducted together rather than separately.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

This disclosure describes a system and a method for partitioning geographic cells. This disclosure also describes a way of determining groups of geographic cells that have similar supply and demand properties.

According to various examples, a method for partitioning a geographic area including: partitioning the geographic area into geographic units; determining, for each respective geographic unit, a central location of the respective geographic unit; determining, for each respective geographic unit, an aggregate demand location of the respective geographic unit based on pick-up locations in the respective geographic unit in a time period; determining, for each respective geographic unit, an aggregate supply location of the respective geographic unit based on provider locations when responding to requests having pick-up locations in the respective geographic unit in said time period; determining, for each respective pair of geographic units among a plurality of the geographic units, a connection strength between the respective pair of geographic units based on distance metrics between the respective pair of geographic units, where the distance metrics are determined based on the central locations, the aggregate supply locations, and the aggregate demand locations of the respective pair of geographic units in said time period; and assigning each respective geographic unit to a respective one of one or more aggregate geographic units based on the determined connection strengths.

To the accomplishment of the foregoing and related ends, the one or more aspects include the features hereinafter fully described and particularly pointed out in the claims. The following description and the associated drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The invention will be better understood with reference to the detailed description when considered in conjunction with the non-limiting examples and the accompanying drawings.

FIG. 1 illustrates a map of a geographic region partitioned into a grid of geographic cells.

FIG. 2 illustrates a block diagram of an example networked environment according to an aspect of the present disclosure.

FIG. 3A illustrates a map that has been partitioned into a grid of geographic cells and FIG. 3B illustrates the grid of geographic cells of FIG. 3A as an undirected weighted graph.

FIGS. 4A and 4B illustrate various distributions of pick-up locations on a map, the pick-up locations associated with requests in a certain time period.

FIGS. 5A and 5B illustrate various distributions of provider locations on a map, the provider locations associated with when the providers respond to requests in a certain time period.

FIGS. 6A and 6B illustrate determined clusters of geocoded cells over a map for geocoded cells at various sizes.

FIGS. 7A and 7B illustrates a flowchart of a method for partitioning a geographical area according to an aspect of the present disclosure.

FIG. 8 illustrates a block diagram of a geographic partitioning system in accordance with various examples.

FIG. 9 illustrates a detailed block diagram of a ride-hailing system 210 in accordance with various examples.

It should be noted that like reference numbers are used to depict the same or similar elements, features, and structures throughout the drawings.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the systems or methods are analogously valid for the other systems or methods. Similarly, embodiments described in the context of a system are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “exemplary” is used herein to mean “serving as an example, instance, or illustration.” Any embodiment or design described herein as “exemplary” is not necessarily to be construed as preferred or advantageous over other embodiments or designs

In the context of various embodiments, the articles “a”, “an”, and “the” as used with regard to a feature or element include a reference to one or more of the features or elements.

As used herein, the term “and/or” includes any and all combinations of one or more of the associated listed items.

The terms “at least one” and “one or more” may be understood to include a numerical quantity greater than or equal to one (e.g., one, two, three, four, [. . . ], etc.). The term “a plurality” may be understood to include a numerical quantity greater than or equal to two (e.g., two, three, four, five, [. . . ], etc.).

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

A geographic area may be partitioned into smaller geographic areas for purposes of determining pricing. However, there may be an inconsistency in the determined pricing if a relationship between geographic sub-areas cannot be determined effectively. For example, there may be a large disparity or difference in price perceived by passengers using different child POIs with same parent POI if these two POIs are sharing similar supply and demand pattern (e.g., a north gate and a south gate of the same stadium). For example, constantly regrouping geographic sub-areas have high computing resource requirements. Thus, an improvement for automatically and dynamically determining relationships between geographic sub-areas rooted in computer technology is needed. Geographic sub-areas (e.g., geohash cells) may be automatically combined based on received supply/demand information and a set of rules to dynamically form virtual sub-groups (e.g., clusters) with similar demand and supply pattern and dynamic pricing (e.g., surge) computation may be conducted based on the identified sub-groups.

For example, geographic cells (e.g., geocoded cells such as geohash cells) corresponding to real world areas may be clustered into a one or more logical aggregated units for surge price calculation. A cluster may be determined utilizing a community detection approach.

Various examples will help to address the large disparity or difference in price perceived by passengers using different child POIs with same parent POI if these two POIs are sharing similar supply and demand pattern.

Various examples describe the geographic cell units as a geohash cell, but it can be easily extended to other geocoding systems (e.g., geohex, google s2, etc) or same geocoding system but different scales (e.g., geohash level 6 or level 7, etc).

To more accurately determine dynamic pricing, geocoded cells that share a similar supply and demand pattern are identified and aggregated into an aggregate geographic unit. The geocoded cells may be grouped or clustered into one or more aggregate geographic units depending on the spatial and temporal supply and demand patterns associated with a regional area in the real world.

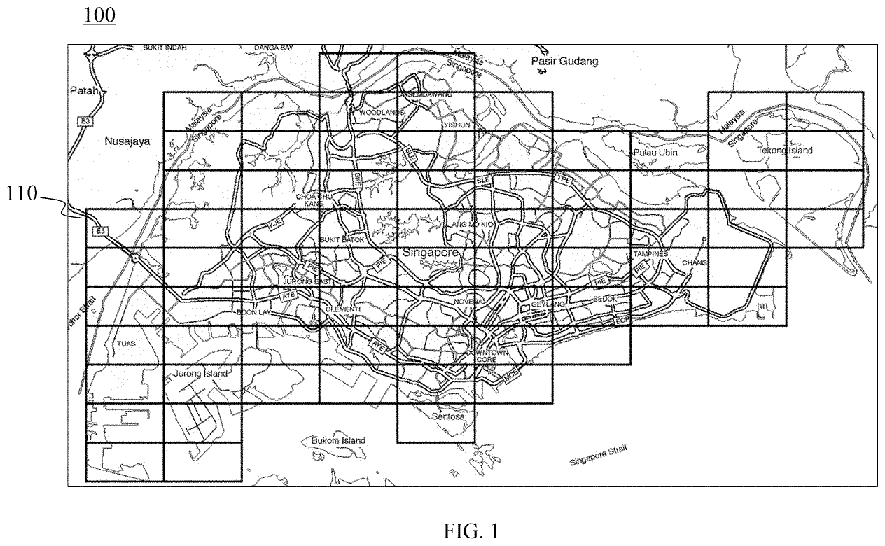

FIG. 1 illustrates a map of a geographic region partitioned into a grid of geographic cells 100. Each geographic cell 110 corresponds to and represents a distinct portion of the overall geographic region. For convenience of identification, each of the geographic cells may be partitioned based on a geocoding system and be identified by a geocode assigned based on the geocoding system. The size and the shape of the geographic cells and the pattern alignment of the geographic cells may be selected based on the geographic region (e.g., population density, terrain, etc.) or the geocoding system used. For example, the grid of geographic cells may be a hexagonal tessellation. The grid of geographic cells may also include geographic cells of different sizes and/or shapes.

The aggregation of geographic units may be determined based on a relationship metric between two geocoded cells. Such a relationship metric should be determinable between any two geocoded cells. A relationship metric may correspond with a connection strength between two geocoded cells (or nodes) and which can be used for community detection for the aggregation or clustering. For example, a relationship metric between two geographic cells may be determined based on various aspects such as a central location of each geometric cell, the location distributions of booking demands (which may include allocated/accepted demands and/or unallocated/canceled demands) in each geographic cell over a certain time period, as well as the corresponding location distributions of suppliers/providers when serving (or responding to) the booking demands in that geographic cell (which may include the acceptances and/or rejections of the booking demands) to define how strong one geographic cell is connected to another geographic cell. In some examples, a relative number of booking demands and suppliers in or between respective geographic cells may be used to modify one or more aspects of the relationship metric. The relationship metric or aspects thereof may be provided to a community detection algorithm which may determine whether geographic cells have a common supply and demand pattern over a particular period of time based on the relationship metrics and form groups of geographic cells based on a determination of a similar supply and demand pattern.

For example, a community detection approach for aggregation may involve organizing the geohash cells into one or more groups or clusters based on the connection strengths between geohash cells (or nodes). In various examples, the central location of each geohash cell, the location distribution of the booking demands (including unallocated/canceled demands) in each geohash cell over a certain time period, as well as the corresponding location distribution of the supply (locations of the drivers when a demand is accepted) when serving the demand in that geohash cell to define how strong one geohash cell is related or connected to another geohash cell.

That is, instead of independently establishing dynamic pricing for arbitrary geographic areas, the supply and demand information can be utilized to derive a geographic framework for determining region based dynamic pricing. An aggregation process based on graph theory can leverage the supply and demand information collected for each geographic unit to combine geographic units with similar demand and supply patterns into one geographic region. Dynamic pricing may be determined based on the geographic region rather than on the individual geographic units, thereby reducing the disparity of dynamic pricing perceived by riders in a geographic area.

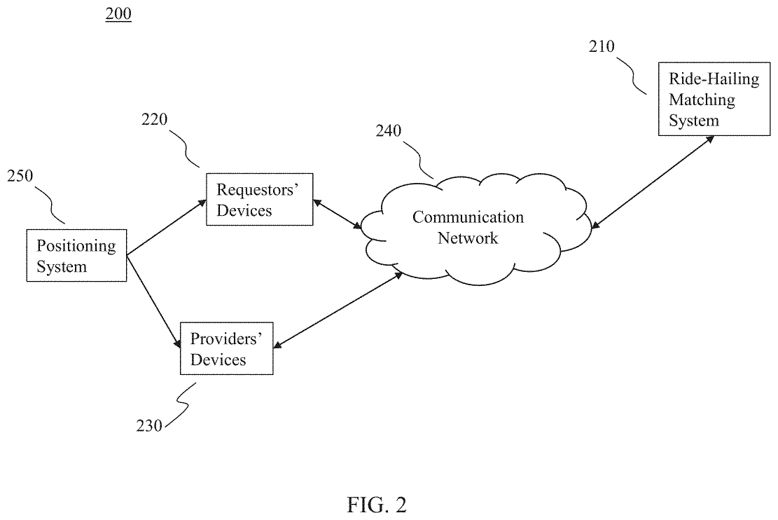

FIG. 2 illustrates a block diagram of an example networked environment 200 where various examples of the present disclosure may be implemented. Networked environment 200 may include a ride-hailing matching system 210, requestors' computing devices 220, providers' computing devices 230, communication network 240, and a positioning system 250. The ride-hailing matching system 210 may be configured to communicate with both the requestors' computing devices 220 and the providers' computing devices 230.

The requestors' computing devices 220 and the providers' computing devices 230 may be multi-purpose mobile computing devices such as smartphones or tablets. The communication network 240 may include a plurality of devices interconnected by wired or wireless datalinks (e.g., the Internet). The positioning system 250 may include a Global Navigation Satellite System (GNSS) such as the Global Positioning System (GPS). The ride-hailing matching system 210 may include a network server, an application server, and/or a database server implemented in a monolithic system or a distributed system.

Each of the requestors' computing devices may be configured with a ride-hailing requestor application. A requestor may use the ride-hailing requestor application to request a ride. The request (i.e., booking demand) may be sent over the communication network 240 to the ride-hailing matching system 210. The booking request may include a request time and a pick-up location. The request time may be a current time or a future time. The pick-up location may be sent as latitude/longitude coordinates or a geocoded designation.

Each of the providers' computing devices may be configured with a ride-hailing provider application. A provider may use the ride-hailing provider application to periodically send over the communication network 240 an availability indication and a current location to the ride-hailing matching system 210. The current location may be sent as latitude/longitude coordinates or a geocoded designation. The provider may be a vehicle driven by a human or autonomously.

The ride-hailing matching system 210 may identify available providers for a particular request and send the request to one or more of the available providers' computing devices. A provider may accept or reject the request through the ride-hailing provider application. The acceptance or rejection may be sent over the communication network 240 to the ride-hailing matching system 210. The acceptance or rejection may include the provider's location when the provider accepted or rejected the request. The acceptance or rejection may also include a timestamp.

The ride-hailing matching system 210 may generate a price and provide the price to the requestor of a ride request and the one or more solicited providers for the ride request. The requester and a solicited provider may independently accept or reject the ride request based on the price. For example, the price may be generated by a dynamic pricing controller of the ride-hailing matching system based on characteristics (e.g., supply and demand information) associated with a geographic region in which the requestor and/or the provider is present.

The providers' devices and the requestors' devices may obtain location information from a positioning system 250.

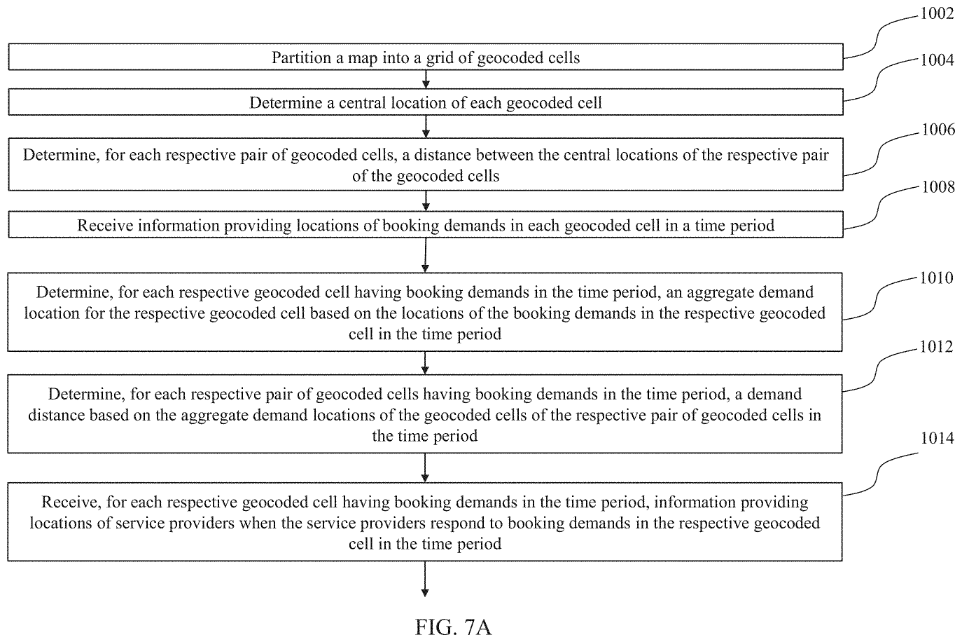

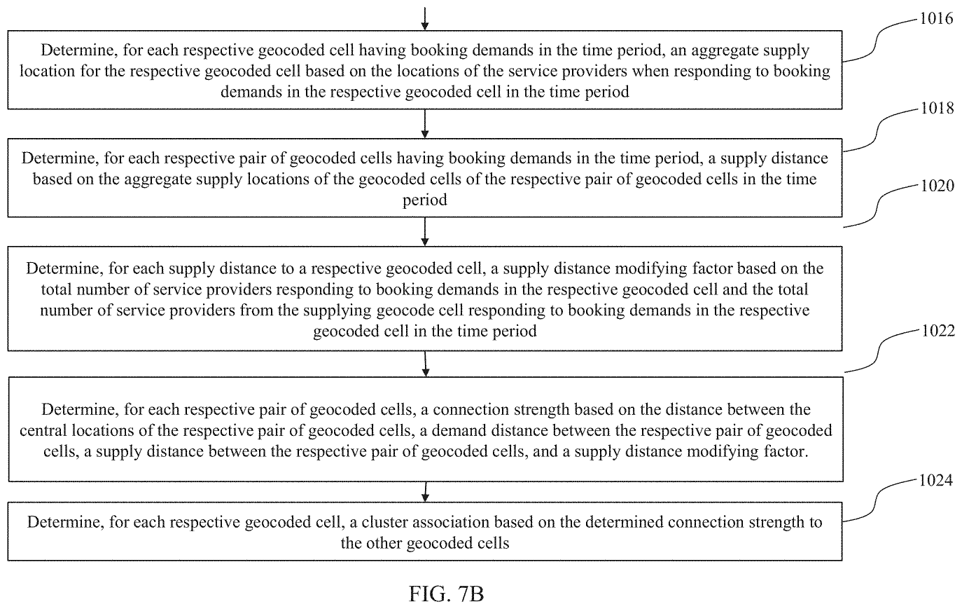

FIGS. 7A-7B is a flowchart of a method for partitioning a geographical area for dynamic pricing in one or more examples of the present disclosure. Although the blocks are illustrated in a sequential order, the processes associated with these blocks may also be performed in parallel, and/or in a different order than those described herein. Also, the processes of the various blocks may be combined, divided into additional blocks, and/or eliminated based upon the desired implementations.

At 1002, one or more processors may partition a map of a region in the real world into a grid of geographic units/cells. Each geographic unit or cell corresponds to an area on the map on a one-to-one basis. For example, a geographic unit or cell may be a geocoded cell (e.g., a geohash, geohex, google S2, etc.). The use of a geocoded cell facilitates the partitioning of a map and identification of a geographic unit or cell. The size of the geographic units or cells may be determined based on a population density and/or a geographic terrain.

At 1004, one or more processors may determine a common location of each geographic unit or cell. For example, the common location of a geographic unit or cell may be a central location of the geographic unit or cell. The central location may be a geometric center of a geocoded cell. For example, in geohash encoding, each geohash cell is rectangular and the central location is a center of the rectangle.

At 1006, one or more processors may determine, for each respective pair of geographic units/cells, a distance between the common locations of the respective pair of the geographic units/cells. For example, the distance may be a central distance based on a Euclidean distance between the geometric centers of the two geocoded cells.

At 1008, one or more processors may receive information providing locations of requests or booking demands in each geographic unit/cell in a time period. For example, a ride-hailing matching system may be implemented on one or more processors configured to receive information associated with one or more requests (i.e., demand communications). Each request includes information about the pick-up location and the pick-up time. The one or more requests may be received as live data in real-time or may be received as historical data previously collected by the ride-hailing matching system. For example, a ride-hailing matching system may include a business circuit and a clustering circuit implemented on one or more processors. Both circuits may be configured to receive information about booking demands in real-time for the time period. Alternatively, the business circuit may be configured to receive information about booking demands in real-time and store the received information about booking demands in a database and the clustering circuit may be configured to receive the information about booking demands from the database for the time period. If the format of the pick-up location is a geocoded designation (e.g., a geohash), then the one or more processors may convert it into latitude/longitude coordinates or 3D Cartesian coordinates.

At 1010, one or more processors may determine, for each respective geographic unit/cell having requests or booking demands in the time period, an aggregate demand location for the respective geographic unit/cell based on the pick-up locations of the requests or booking demands in the respective geographic unit/cell in the time period. For example, for each geocoded cell, the clustering circuit may be configured to determine an aggregate demand location for a respective geocoded cell by averaging the pick-up locations (e.g., corresponding latitude/longitude coordinates) of the requests having a pick-up location in the respective geocoded cell and having a pick-up in the time period. For example, an aggregate demand location may be based on the averaged latitude coordinates and the averaged longitude coordinates of the pick-up locations. Alternatively, an aggregate demand location may be based on the averaged 3D Cartesian coordinates of the pick-up locations. An averaging may an arithmetic average or a geometric average (e.g., centroid) of the pick-up locations.

At 1012, one or more processors may determine, for each respective pair of geographic units/cells having booking demands in the time period, a demand distance based on the aggregate demand locations of the geographic units/cells of the respective pair of geographic units/cells in the time period. For example, the clustering circuit may be configured to determine a demand distance for each respective pair of geocoded cells by determining a Euclidean distance between the aggregate demand locations of the geocoded cells in the respective pair of geocoded cells in the time period. Alternatively, the demand distance may be based on a routing distance between the aggregate demand locations. In some examples, the one or more processors may determine a demand distance for each respective pair of geocoded cells of only a subset of geocoded cells for purposes of reducing latency or computations, increasing speed, and/or improving efficiency. For example, the subset of geocoded cells may be limited to geocoded cells within a range of cell hops or within a maximum distance of each other. For example, in geohash encoding the range of cell hops may be different at different geohash levels. The range of cell hops may be larger at higher geohash levels (i.e., smaller geohash cells) and smaller at lower geohash levels (i.e., larger geohash cells). The range of hops may correspond to an equivalent maximum distance. When the size of geographic cells is small, each respective pair of geographic cells of the subset may not be limited to adjacent neighboring cells.

At 1014, one or more processors may receive, for each respective geographic unit/cell having booking demands in the time period, information providing locations of service providers when the service providers respond to requests or booking demands in the respective geographic unit/cell in the time period. For example, the clustering circuit may be configured to receive information associated with one or more acceptances/rejections (i.e., supply communications) in response to the one or more requests. Each response includes information about the time and location of a respective provider at the time when the respective provider sends the response, i.e., response time and response location. The one or more responses may be received as live data in real-time or may be received as historical data previously collected by the ride-hailing matching system. For example, the business circuit and clustering circuit may both be configured to receive information about responses to booking demands in real time for the time period. Alternatively, the business circuit may be configured to receive information about responses to booking demands in real-time and store the received information about the responses to booking demands in a database and the clustering circuit may be configured receive the information about the responses to booking demands from the database for the time period. If the format of the response location is a geocoded designation (e.g., a geohash), then the one or more processors may convert it into latitude/longitude coordinates.

At 1016, one or more processors may determine, for each respective geographic unit/cell having requests or booking demands in the time period, an aggregate supply location for the respective geographic unit/cell based on the locations of the service providers when responding to booking demands in the respective geographic unit/cell in the time period. For example, the clustering circuit may be configured to determine an aggregate supply location for a geocoded cell by averaging the response locations (e.g., corresponding latitude/longitude coordinates) of the responses to requests having a pick-up location in the geocoded cell and having a pick-up in the time period. For example, an aggregate supply location may be based on the averaged latitude coordinates and the averaged longitude coordinates of the drivers' locations when responding to booking demands. Alternatively, an aggregate demand location may be based on the averaged 3D Cartesian coordinates of the drivers' locations when responding to booking demands. An averaging may an arithmetic average or a geometric average (e.g., centroid) of the drivers' locations when responding to booking demands.

At 1018, one or more processors may determine, for each respective pair of geographic units/cells having booking demands in the time period, a supply distance based on the aggregate supply locations of the geographic cells of the respective pair of geographic cells in the time period. For example, the clustering circuit may be configured to determine a supply distance for each respective pair of geocoded cells by determining a Euclidean distance between the aggregate supply locations of the geocoded cells in the respective pair of geocoded cells in the time period. Alternatively, the supply distance may be based on a routing distance between the aggregate demand locations. In some examples, the one or more processors may determine a supply distance for each respective pair of geocoded cells of only a subset of geocoded cells for purposes of reducing latency or computations, increasing speed, and/or improving efficiency. For example, the subset of geocoded cells may be limited to geocoded cells within a range of cell hops or within a maximum distance of each other. For example, in geohash encoding the range of cell hops may be different at different geohash levels. The range of cell hops may be larger at higher geohash levels (i.e., smaller geohash cells) and smaller at lower geohash levels (i.e., larger geohash cells). The range of hops may correspond to an equivalent maximum distance. When the size of geographic cells is small, each respective pair of geographic cells of the subset may not be limited to adjacent neighboring cells.

At 1020, one or more processors may determine, for each supply distance to a respective geographic unit/cell, a supply distance modifying factor based on the total number of service providers responding to requests or booking demands in the respective geographic cell and the total number of service providers from the supplying geographic cell responding to booking demands in the respective geographic cell in the time period. For example, the clustering circuit may be configured to determine a supply distance modifying factor for each supply distance, where a supply distance modifying factor of a supply distance between the aggregate supply location of the respective geocoded cell and the aggregate supply location of another geocoded cell may be a ratio based on the total number of providers accepting requests in the respective geocoded cell and the number of providers from the other geocoded cell accepting requests in the respective geocoded cell. In other examples, the supply distance modifying factor may also be adjusted based on the number of providers from the other geocoded cell rejecting requests in the respective geocoded cell or the number of booking requests canceled in the respective geocoded cell associated with providers accepting from the other geocoded cell.

At 1022, one or more processors may determine, for each respective pair of geographic units/cells, a connection strength based on the distance between the common locations of the respective pair of geographic units/cells, a demand distance between the respective pair of geographic units/cells, a supply distance between the respective pair of geographic units/cells, and a supply distance modifying factor. For example, the clustering circuit may be configured to determine a connection strength between two geocoded cells in both directions based on a central distance, a demand distance, and a supply distance. Additionally, a supply distance modifying factor for each direction used to determine the connection strength. The connection strength is a metric indicating whether a pair of geocoded cells is likely to have similar supply and demand patterns. In some examples, the one or more processors may determine a connection strength for each respective pair of geocoded cells of only a subset of geocoded cells for purposes of reducing latency or computations, increasing speed, and/or improving efficiency. For example, the subset of geocoded cells may be limited to geocoded cells within a range of cell hops or within a maximum distance of each other.

At 1024, one or more processors may use the determined connection strength of the geographic cells to group the geographic cells into one or more geographic clusters and partitioning a geographic map accordingly. For example, the clustering circuit may be configured to apply a community detection algorithm that generates one or more aggregate units by combining one or more geographic cells having similar characteristics into an aggregate unit (i.e., cluster). Each generated cluster may be assigned a respective cluster label.

At 1026 (not shown), one or more processors may, for each determined cluster, generate supply and demand information corresponding to the respective determined cluster and provide the cluster supply and demand information. For example, the clustering circuit may be configured to generate cluster demand information for a respective cluster by combining the demand information of each geographic cell belonging to the respective cluster. Similarly, the clustering circuit may be configured to generate cluster supply information for a respective cluster by combining the supply information of each geographic cell belonging to the respective cluster. The cluster supply and demand information may be generated based on supply and demand information associated with a particular period of time. The clustering circuit may be configured to provide the cluster supply and demand information of each respective cluster to a dynamic pricing circuit. The clustering circuit may also provide information identifying the constituent geographic cells of each respective cluster including the cluster label to the dynamic pricing circuit. The dynamic pricing circuit may determine dynamic pricing for a respective cluster (associated with a geographic region) based on the respective cluster supply and demand information.

The clustered supply (or demand) information/signal may be computed based on the arithmetic or geometric average of the aggregate supply (or demand) locations of all geographic units/cells associated with an aggregate geographic unit for the particular time period, and subsequently each geographic unit/cell of the aggregate geographic unit is assigned the clustered supply (or demand) information/signal (i.e. averaged value) of the aggregate geographic unit for the particular time period. The aggregate geographic unit may be a logical representation of related geographic units/cells and the geographic units/cells may not be actually combined. In some examples, the cluster supply information signal of a cluster may be a cluster supply location determined based on an arithmetic or geometric average of the aggregate supply locations of all geocoded cells of the respective cluster. The aggregate supply location of each geocoded cell of the respective cluster may be reassigned the averaged aggregate supply location associated with the respective cluster (i.e., the cluster supply location information), however, the map size may remain the same. Similarly, the cluster demand information signal of a cluster may be a cluster demand location determined based on an arithmetic or geometric average of the aggregate demand locations of all the geocoded cells of the respective cluster. The aggregate demand location of each geocoded cell of the respective cluster may be reassigned the averaged aggregate demand location (i.e., the cluster demand location information), however, the map size may remain the same. For example, the individual geocoded cells of a respective cluster may not be combined to form a block of geocoded cells on the map, but rather the individual geocode cells may remain individual cells with assigned cluster information based on the cluster relationships of the present time period. This is because the supply and demand distributions may change quickly over time, and thus, the cluster relationships and cluster information may change correspondingly. Due to dynamic cluster formations, it may be more efficient to maintain clustering information association at the geographic unit/cell level. For example, such logical representation facilitates real-time dynamic clustering.

In an example, (xᵢ^{G}, yᵢ^{G}) denotes the latitude and longitude of the center location of geohash cell i and (xⱼ^{G}, yⱼ^{G}) denotes the latitude and longitude of the center location of geohash cell j. A Euclidean distance from the center of geohash cell j to the center of geohash cell i may be defined as:

d_{j→i}^{G}=\sqrt{(xᵢ^{G}−xⱼ^{G})²+(yᵢ^{G}−yⱼ^{G})²} (Eq. 1)

A Euclidean distance from the center of geohash cell i to the center of geohash cell j may be defined as:

d_{i→j}^{G}=\sqrt{(xⱼ^{G}−xᵢ^{G})²+(yⱼ^{G}−yᵢ^{G})²} (Eq. 2)

Therefore, the Euclidean distance between the centers of two geohash cells are not directionally dependent, i.e., d_{j→i}^{G}=d_{i→j}^{G}. Accordingly, a distance between the centers of adjacent geohash cells is smaller than a distance between the centers of non-adjacent geohash cells. Adjacent geohash cells have small distance from their centers.

(xᵢ^{D}, yᵢ^{D}) denotes the latitude and longitude of each pick-up location of booking demands in geohash cell i over a particular period of time and (xⱼ^{D}, yⱼ^{D})denotes the latitude and longitude of each pick-up location of booking demands in geohash cell j over the same particular period of time. (\acute{x}ᵢ^{D}, ýᵢ^{D}) denotes an aggregate pick-up location of booking demands in geohash cell i of over the particular period of time. (\acute{x}ⱼ^{D}, ýⱼ^{D}) denotes an aggregate pick-up location of booking demands in geohash cell j of over the same particular period of time. The aggregate pick-up location may be an average or geometric mean of the pick-up locations in a geohash cell. Specifically,

$${{x}^{´}}_{i}^{D} = \frac{{\sum }_{{n}_{i}^{D}} {x}_{i}^{D}}{{n}_{i}^{D}} and {ý}_{i}^{D} = \frac{{\sum }_{{n}_{i}^{D}} {y}_{i}^{D}}{{n}_{i}^{D}} \qquad ( Eq . 3 )$$

where nᵢ^{D} the total number of booking demands in geohash cell i. Similarly,

$${{x}^{´}}_{j}^{D} = \frac{{\sum }_{{n}_{j}^{D}} {x}_{j}^{D}}{{n}_{j}^{D}} and {ý}_{j}^{D} = \frac{{\sum }_{{n}_{j}^{D}} {y}_{j}^{D}}{{n}_{j}^{D}} \qquad ( Eq . 4 )$$

where nⱼ^{D} is the total number of booking demands in geohash cell j. A Euclidean distance from the aggregate pick-up location of geohash cell j to the aggregate pick-up location of geohash cell i may be defined as:

d_{j→i}^{G}=\sqrt{(\acute{x}ᵢ^{D}−\acute{x}ⱼ^{D})²+(ýᵢ^{D}−ýⱼ^{D})²} (Eq. 5)

A Euclidean distance from the aggregate pick-up location of geohash cell i to the aggregate pick-up location of geohash cell j may be defined as:

d_{i→j}^{D}=\sqrt{(\acute{x}ⱼ^{D}−xᵢ^{d})²+(ýⱼ^{D}−yᵢ^{D})²} (Eq. 6)

Therefore, the Euclidean distance of demand between the aggregate pick-up locations of two geohash cells are not directionally dependent, i.e., d_{j→i}^{D}=d_{i→j}^{D}.

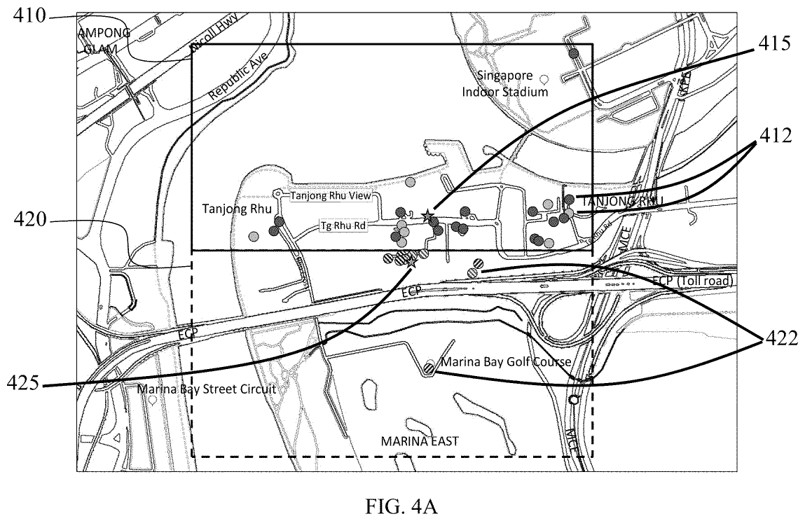

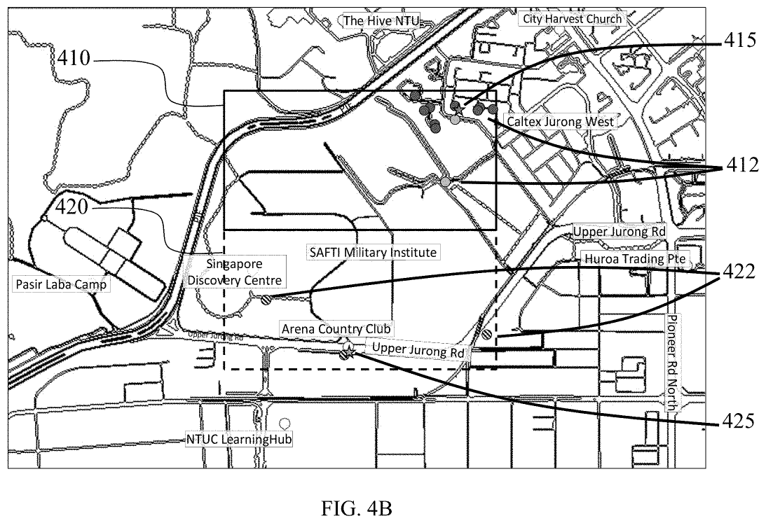

FIGS. 4A-4B illustrate maps showing pick-up locations in two adjacent geohash cells. More specifically, FIGS. 4A-4B illustrate maps including neighboring geohash cells 410 and 420. The darkened dots indicate the pick-up locations 412 of booking demands generated in geohash cell 410 during a particular period of time (e.g., Monday 8 am-9 am). Similarly, the hash-filled dots indicate the pick-up locations 422 of booking demands generated in geohash cell 420 during the same particular period of time (e.g., Monday 8 am-9 am). The darkened star indicates an aggregate pick-up location 415 of the booking demands in geohash cell 410 and the hash-filled star indicates an aggregate pick-up location 425 of the booking demands in geohash cell 420. For example, the aggregate pick-up locations 415 and 425 are geometric means of the pick-up locations distributed in geohash cells 410 and 420, respectively. In the example, the period of time of is one hour, however the period of time may be shorter or longer. For example, when a concert lets out or when there is a sudden thunderstorm, the supply and demand information may change abruptly necessitating shorter time periods.

The example figures show that a demand distance between two geohash cells differs for different distributions of booking demands in the geohash cells. For example, FIG. 4A illustrates distribution of pick-up locations in two adjacent geohash cells where the pick-up locations 412, 422 of each geohash cell 410, 420 are clustered near a cell border that is shared by the geohash cells. Accordingly, the aggregate pick-up locations 415 and 425 are also near the shared cell border. For another example, FIG. 4B illustrates a distribution of pick-up locations in different geohash cells that are separately clustered, where pick-up locations 412 of geohash cell 410 are generally separate from pick-up locations 422 of geohash cell 420. The demand distance, i.e., the distance between the aggregate pick-up locations or demand points of the two geohash cells of FIG. 4A is much smaller than the demand distance of the two geohash cells of FIG. 4B.

Referring again to FIG. 4A, the map is centered about the Tanjong Rhu residential area in Singapore. The map shows that the Singapore River is north of (above) the residential area and a highway and the Marina Bay Golf Course is south of (below) the residential area. However, the residential area is arbitrarily divided over two geocoded cells. The geohash cell 410 includes part of the Singapore River and a northern portion of the Tanjong Rhu residential area and geohash cell 420 includes a southern portion of the Tanjong Rhu residential area, the highway, and the Marina Bay Golf Course. Even without information about the infrastructure or geographical constraints, the demand distance between the two geohash cells may indicate that the demand patterns of the two geohash cells are similar. For example, the demand patterns of the two geohash cells are similar when the distributions of the pick-up locations in two geohash cells have similar geometric means, i.e., when a demand distance between two geohash cells is much smaller than a distance between the central points of the two geohash cells. Referring again to FIG. 4B, the map is centered about the SAFTI military installation in Singapore. The map shows the Jurong West neighborhood/district is northeast of the military installation and the Joo Koon neighborhood/district is southwest of the military installation. The geohash cell 410 includes a portion of the Jurong West neighborhood/district in the northwest corner of geohash cell 410 and geohash cell 420 includes a portion of the Joo Koon neighborhood/district near the southern cell border of geohash cell 420. Even without information about the infrastructure or geographical constraints, the demand distance between the two geohash cells may indicate that the demand patterns of the two geohash cells are different. For example, the demand patterns of the two geohash cells are different when the distributions of the pick-up locations in two geohash cells have very different geometric means, i.e., when a demand distance between two geohash cells is much larger than a distance between the central points of the two geohash cells.

Accordingly, a connection strength between two geohash cells may be based on a distance between the aggregate pick-up locations of the two geohash cells. In general, the Euclidean distance of demand of two adjacent geohash cells will be shorter when their demand distributions are similar or close to each other, and will be longer when their demand distributions are different or separated.

(xᵢ^{S}, yᵢ^{S})denotes the latitude and longitude of a driver's location when the driver accepts a booking demand in geohash cell i over a particular period of time and (xⱼ^{S}, yⱼ^{S}) denotes the latitude and longitude of a driver's location when the driver accepts a booking demand in geohash cell j over the same particular period of time. The aggregate drivers' location for geohash cell i may be an average or geometric mean of the drivers' locations when responding to booking demands in geohash cell i. Specifically,

$${{x}^{´}}_{i}^{S} = \frac{{\sum }_{{n}_{i}^{S}} {x}_{i}^{S}}{{n}_{i}^{S}} and {ý}_{i}^{D} = \frac{{\sum }_{{n}_{i}^{S}} {y}_{i}^{S}}{{n}_{i}^{S}} \qquad ( Eq . 7 )$$

where nᵢ^{S} the total number of drivers, i.e., supply, when accepting and/or serving booking demands in geohash cell i. Similarly,

$${{x}^{´}}_{j}^{S} = \frac{{\sum }_{{n}_{j}^{S}} {x}_{j}^{S}}{{n}_{j}^{S}} and {ý}_{j}^{D} = \frac{{\sum }_{{n}_{j}^{S}} {y}_{j}^{S}}{{n}_{j}^{S}} \qquad ( Eq . 8 )$$

where nⱼ^{S} is the total number of drivers, i.e., supply, when accepting and/or serving booking demands in geohash cell j. A Euclidean distance from the aggregate drivers' location for geohash cell j to the aggregate driver's location for geohash cell i may be defined as:

d_{j→i}^{S}=\sqrt{(\acute{x}ᵢ^{S}−\acute{x}ⱼ^{S})²+(ýᵢ^{S}−ýⱼ^{S})²} (Eq. 9)

A Euclidean distance from the aggregate drivers' location for geohash cell i to the aggregate driver's location for geohash cell j may be defined as:

d_{i→j}^{S}=\sqrt{(\acute{x}ⱼ^{S}−\acute{x}ᵢ^{S})²+(ýⱼ^{S}−ýᵢ^{S})²} (Eq. 10)

Therefore, the Euclidean distance of supply between the aggregate drivers' locations of two geohash cells are not directionally dependent, i.e., d_{j→i}^{S}=d_{i→j}^{S}.

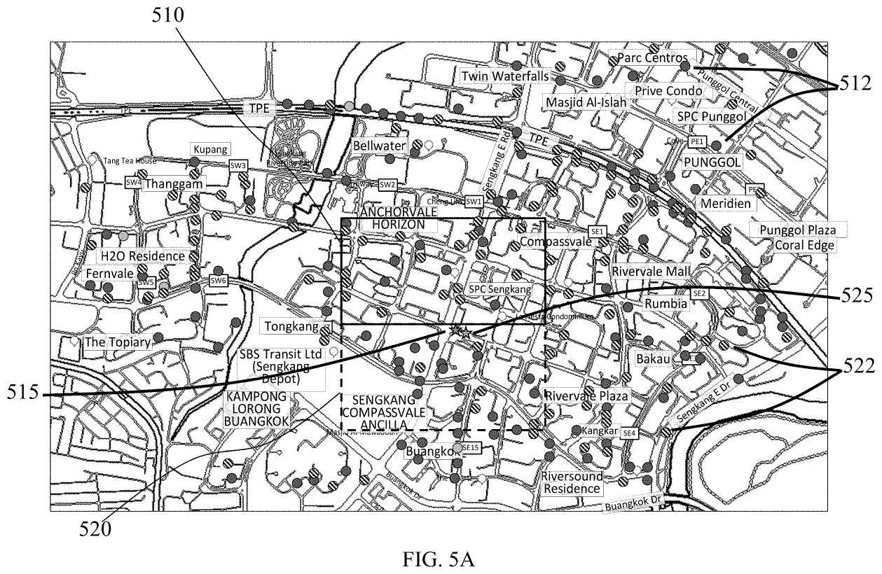

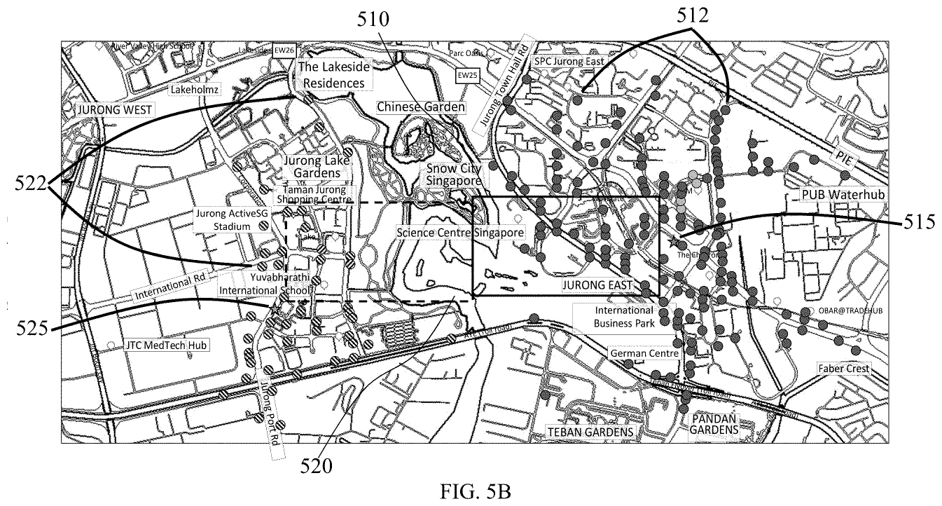

FIGS. 5A-5B illustrate maps showing drivers' locations when responding to booking demands in two adjacent geohash cells. More specifically, FIGS. 5A-5B illustrate maps including neighboring geohash cells 510 and 520. The darkened dots indicate the drivers' locations 512 when responding to booking demands generated in geohash cell 510 during a particular period of time (e.g., Monday 8 am-9 am). The particular period of time should be the same as the particular period of time for determining the aggregate pick-up location for the geohash cell. Similarly, the hash-filled dots indicate the drivers' locations 522 when responding to booking demands generated in geohash cell 520 during the same particular period of time (e.g., Monday 8 am-9 am). The darkened star indicates an aggregate drivers' location 515 when responding to the booking demands in geohash cell 510 and the hash-filled star indicates an aggregate drivers' location 525 when responding to the booking demands in geohash cell 520. For example, the aggregate drivers' location 515 is a geometric mean of the distribution of drivers' locations when responding to booking demands in geohash cells 510. Similarly, the aggregate drivers' location 525 is a geometric mean of the distribution of drivers' locations when responding to booking demands in geohash cell 520.

The example figures show that a supply distance between two geohash cells differs for different distributions of drivers' locations when accepting booking demands in the geohash cells. For example, FIG. 5A illustrates distributions of drivers' locations when accepting booking demands in two adjacent geohash cells. The drivers' locations 512 when accepting booking demands in geohash cell 510 are distributed in and around geohash cells 510 and 520 and the drivers' locations 522 when accepting booking demands in geohash cell 520 are distributed in and around geohash cells 510 and 520. In the example of FIG. 5A, the aggregate drivers' location 515 when accepting booking demands in geohash cell 510 and the aggregate drivers' location 525 when accepting booking demands in geohash cell 520 are very close to each other because the distributions of drivers' locations are similar and have a similar geometric mean. That is, the supply distribution for geohash cells 510 and 520 are commingled. For another example, FIG. 5B illustrates different distributions of drivers' locations when accepting booking demands in two adjacent geohash cells. The drivers' locations 512 when accepting booking demands in geohash cell 510 are distributed around of a cell border of geohash 510 that is not shared with geohash cell 520 and the drivers' locations 522 when accepting booking demands in geohash cell 520 are distributed around a portion of geohash cell 520 that is facing away from geohash cell 510. That is, the supply distribution for geohash cells 510 and 520 are not commingled. FIG. 5B illustrates distributions of drivers' locations for different geohash cells that are separately clustered, where drivers' locations 512 of geohash cell 510 are generally separate from drivers' locations 522 of geohash cell 520. In the example of FIG. 5B, the aggregate drivers' location 515 when accepting booking demands in geohash cell 510 and the aggregate drivers' location 525 when accepting booking demands in geohash cell 520 are far apart from each other because the distributions of drivers' locations are different and have different geometric means. The supply distance, i.e., the distance between the aggregate drivers' locations for the two geohash cells of FIG. 5A is much smaller than the supply distance of the two geohash cells of FIG. 5B.

Referring again to FIG. 5A, the map is centered about the Sengkang residential area in Singapore. The map shows that the residential area is arbitrarily divided over two geocoded cells. The geohash cell 510 includes a northern portion of the Sengkang residential area and geohash cell 520 includes a southern portion of the Sengkang residential area. Even without information about the infrastructure or geographical constraints, the supply distance between the two geohash cells may indicate that the supply patterns of the two geohash cells are similar. For example, the supply patterns of the two geohash cells are similar when the distributions of the drivers' locations when responding to booking demands in two geohash cells have similar geometric means, i.e., when a supply distance between two geohash cells is much smaller than a distance between the central points of the two geohash cells. Referring again to FIG. 5B, the map is centered about Jurong Lake in Singapore and shows that the Lakeside neighborhood/district is west of Jurong Lake and the Jurong East neighborhood/district is east of Jurong Lake. As shown in FIG. 5B, a portion of Jurong Lake is arbitrarily divided over two geocoded cells. The geohash cell 510 includes a portion of the Lakeside neighborhood/district in the eastern portion of geohash cell 510 and a portion of Lake Jurong in the western portion of geohash cell 510 and geohash cell 520 includes a portion of Lake Jurong in the eastern portion of geohash cell 520 and a portion of the Jurong East neighborhood/district in the western portion of geohash cell 350. Even without information about the infrastructure or geographical constraints, the supply distance between the two geohash cells may indicate that the supply patterns of the two geohash cells are different. For example, the supply patterns of the two geohash cells may be different when the distributions of the drivers' locations in two geohash cells have very different geometric means, i.e., when a supply distance between two geohash cells is much larger than a distance between the central points of the two geohash cells.

Accordingly, a connection strength between two geohash cells may be based on a distance between the aggregate drivers' locations of the two geohash cells. In general, the Euclidean distance of supply of two adjacent geohash cells will be shorter when their supply distributions are similar or close to each other, and will be longer when their supply distributions are different or separated.

The supply distance of Eqs. 9 and 10 is based on aggregate drivers' locations including all drivers (i.e., providers or supply) accepting and/or serving booking demands in a geohash cell. As the supply distance does not consider drivers' locations in particular cells an additional factor may be used to adjust the supply distance between two geohash cells to account for the source of the supply. For example, to account for the supply in geohash cell j to the demands in geohash cell i, a modifying factor may be a ratio of the number of drivers from geohash cell j accepting and/or serving booking demands in geohash cell i to the total number of drivers from anywhere accepting and/or serving booking demands in geohash cell i. Similarly, to account for the supply in geohash cell i to the demands in geohash cell j, a modifying factor may be a ratio of the number of drivers from geohash cell i accepting and/or serving booking demands in geohash cell j to the total number of drivers from anywhere accepting and/or serving booking demands in geohash cell j. Such modifying factors may be defined as

$${γ}_{j \to i}^{S} = \frac{{n}_{j \to i}^{S}}{{n}_{i}^{S}} and {γ}_{i \to j}^{S} = \frac{{n}_{i \to j}^{S}}{{n}_{j}^{S}} \qquad ( Eq . 11 )$$

where n_{j→i}^{S} is the total number of drivers, i.e., supply, from geohash cell j accepting and/or serving booking demands in geohash cell i and where nᵢ^{S} is the total number of drivers, i.e., supply, from anywhere accepting and/or serving booking demands in geohash cell i. As such, nᵢ^{S} may be determined by summing up the total number of drivers from each geohash cell that accepts and/or serves booking demands in geohash cell i. For example, nᵢ^{S}=Σ_{K}n_{k→i}^{S}, where K is the total number of geohash cells including supply for geohash cell i and n_{k→i}^{S} indicates a k^{th} geohash cell including supply for geohash cell i. Similarly, n_{i→j}^{S} is the total number of drivers, i.e., supply, from geohash cell i accepting and/or serving booking demands in geohash cell j and where nⱼ^{S} of is the total number of drivers, i.e., supply, from anywhere accepting and/or serving booking demands in geohash cell j. As such, nⱼ^{S} of may be determined by summing up the total number of drivers from each geohash cell that accepts and/or serves booking demands in geohash cell j. For example, nⱼ^{S}=Σ_{H}n_{h→j}^{S}, where H is the total number of geohash cells including supply for geohash cell j and n_{h→i}^{S} indicates an h^{th} geohash cell including supply for geohash cell i. Accordingly, 0≤γ_{j→i}^{S}≤1 and 0≤γ_{i→j}^{S}≤1. Thus, the modified Euclidean distance of supply from geohash cell j to geohash cell i may be defined as:

d′_{j→i}^{S}=d_{j→i}^{S}(1−γ_{j→i}^{S}) (Eq. 12)

And the modified Euclidean distance of supply from geohash cell i to geohash cell j may be defined as:

d′_{i→j}^{S}=d_{i→j}^{S}(1−γ_{i→j}^{S}) (Eq. 13)

The modifying factors are based on the underlying idea that if the majority of the supply serving booking demands in geohash cell i (or vice versa, geohash cell j) comes from geohash cell j (or vice versa, geohash cell i), the modified Euclidean distance of supply will become shorter. The modifying factor is also directional as the supply from geohash cell j accepting and/or serving demands in geohash cell i may differ from the supply from geohash cell i serving demands in geohash cell i. That is, Γ_{j→i}^{S}≠γ_{i→j}^{S} so, d′_{j→i}^{S}≠d′_{i→j}^{S}.

Accordingly, a connection strength between two geohash cells may be based on a modified distance between the aggregate drivers' locations of the two geohash cells. In general, the modified Euclidean distance of supply will be shorter than the unmodified Euclidean distance of supply, when the supply distributions of the two geohash cells are similar or close to each other, and will be longer when their supply distributions are different or separated.

A connection strength between two geocoded cells may be based on a distance between the two geocoded cells, a demand distance between the two geocoded cells, and a modified supply distance between the two geocoded cells. For example, a connection strength from geohash cell j to geohash cell i may be defined as

$${ω}_{j \to i} = \frac{1}{{d}_{j \to i}^{G} + {d}_{j \to i}^{D} + {d}_{j \to i}^{′S}} \qquad ( Eq . 14 )$$

where the greater the value of ω_{j→i}, the stronger geohash cell j is connected to geohash cell i. Similarly, a connection strength from geohash cell i to geohash cell j may be defined as

$${ω}_{i \to j} = \frac{1}{{d}_{i \to j}^{G} + {d}_{i \to j}^{D} + {d}_{j \to i}^{′S}} \qquad ( Eq . 15 )$$

Since the modified supply distance is directional (i.e., d′_{j→i}^{S}≠d′_{i→j}^{S}), the connection strength is similarly directional (i.e., ω_{j→i}≠ω_{i→j}).

Alternatively, in another example, instead of modifying the supply distance, when determining a supply distance between two geocoded cells, an aggregate drivers' location for a geocoded cell may be supply-demand cell specific. For example, an aggregate drivers' location for a demand geocoded cell may be based on only the drivers' location in a supply geocoded cell when accepting booking demands in the demand geocoded cell, and vice versa. For example, (x_{j→i}^{S}, y_{j→i}^{S}) denotes the latitude and longitude of a driver's location when the driver accepts from geohash cell j a booking demand in geohash cell i over a particular period of time and (x_{i→j}^{S}, y_{i→j}^{S}) denotes the latitude and longitude of a driver's location when the driver accepts from geohash cell i a booking demand in geohash cell j over the same particular period of time. The aggregate drivers' location for geohash cell i from geohash cell j may be an average or geometric mean of the drivers' locations in geohash cell j when responding to booking demands in geohash cell i. Specifically,

$${{x}^{´}}_{j \to i}^{S} = \frac{{\sum }_{{n}_{j \to i}^{S}} {x}_{j \to i}^{S}}{{n}_{j \to i}^{S}} and {ý}_{j \to i}^{D} = \frac{{\sum }_{{n}_{j \to i}^{S}} {y}_{j \to i}^{S}}{{n}_{j \to i}^{S}} \qquad ( Eq . 16 )$$

where n_{j→i}^{S} is the total number of supply from geohash cell j when serving booking demands in geohash cell i. Similarly,

$${{x}^{´}}_{i \to j}^{S} = \frac{{\sum }_{{n}_{i \to j}^{S}} {x}_{i \to j}^{S}}{{n}_{i \to j}^{S}} and {ý}_{j}^{D} = \frac{{\sum }_{{n}_{i \to j}^{S}} {y}_{i \to j}^{S}}{{n}_{i \to j}^{S}} \qquad ( Eq . 17 )$$

where n_{i→j}^{S} is the total number of supply from geohash cell i when serving booking demands in geohash cell j. In this example, a Euclidean distance from the aggregate drivers' location for geohash cell j to the aggregate drivers' location for geohash cell i may be defined as:

d_{j→i}^{S}={square root over ((\acute{x}_{j→i}^{S}−\acute{x}_{i→j}^{S})²+(ý_{j→i}^{S}−ý_{i→j}^{S})²))} (Eq. 18)

Similarly, a Euclidean distance from the aggregate drivers' location for geohash cell j to the aggregate driver's location for geohash cell i may be defined as:

d_{i→j}^{S}={square root over ((\acute{x}_{j→i}^{S}−\acute{x}_{j→i}^{S})²+(ý_{i→j}^{S}−ý_{j→i}^{S})²))} (Eq. 19)

Therefore, the Euclidean distance of supply between the aggregate driver's locations of two geohash cells are not directionally dependent, i.e., d_{j→i}^{S}=d_{i→j}^{S}.

In this case, a connection strength from geohash cell j to geohash cell i may be defined as

$${ω}_{j \to i} = \frac{1}{{d}_{j \to i}^{G} + {d}_{j \to i}^{D} + {d}_{j \to i}^{S}} \qquad ( Eq . 20 )$$

And a connection strength from geohash cell i to geohash cell j may be defined as

$${ω}_{i \to j} = \frac{1}{{d}_{i \to j}^{G} + {d}_{i \to j}^{D} + {d}_{i \to j}^{S}} \qquad ( Eq . 21 )$$

The connection strength is not directionally dependent (i.e., ω_{j→i}=ω_{i→j}).

The connection strength of the geocoded cells can be used to partition a city map (i.e., graph) into clusters and assign cluster labels accordingly. Once a connection strength between each of the geocoded cells have been determined, the geocoded cells may be grouped into one or more aggregate units or clusters based on the connection strengths. The geocoded cells of each aggregate unit or cluster would have similar supply and demand patterns. Since each geocoded cell corresponds to a real world area, the determined one or more aggregate units or clusters also correspond to one or more aggregated real world regions on a one-to-one basis. In this manner, a city map, for example, may be partitioned into a grid of geocoded cells which are then grouped into one or more clusters, each cluster having a supply and demand pattern that is different than a neighboring cluster. The city map may be segmented based on the one or more clusters and labeled correspondingly.

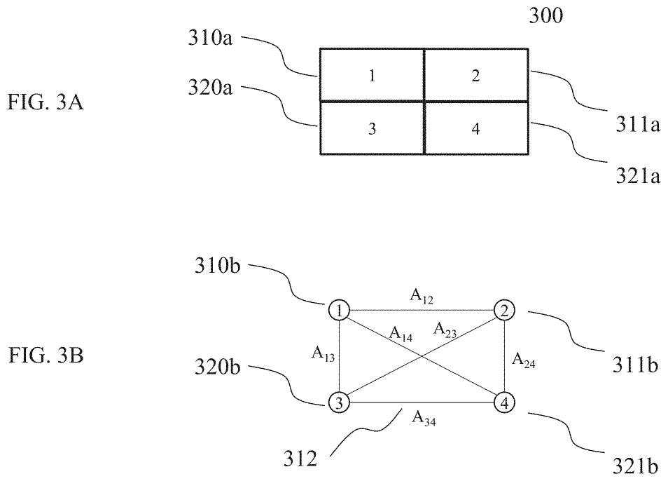

A city map may be represented as a graph map. A city map may be partitioned into a grid of geohash cells and the grid of geohash cells may be represented as an undirected weighted graph, where each geohash cell corresponds to a node or vertex of the graph. For example, geohash cells i and j may be represented as vertices of a graph and Aᵢⱼ represents the weight of the edge between vertex i (corresponding to geohash cell i) and vertex j (corresponding to geohash cell j). FIG. 3A illustrates a city map that has been partitioned into a grid of geohash cells. FIG. 3B illustrates the grid of geohash cells of FIG. 3A as an undirected weighted graph. As shown in FIGS. 3A-3B, a map 300 is partitioned into a grid of geohash cells 310a, 311a, 320a, and 321a where, for example, geohash cell 1 310a in FIG. 3A corresponds to vertex 1 310b of FIG. 3B, geohash cell 2 311a in FIG. 3A corresponds to vertex 2 311b of FIG. 3B, etc. Each edge between vertices may be assigned a weight Aᵢⱼ, where the weight Aᵢⱼ may be based on a connection strength of the vertices. For example, the weight Aᵢⱼ of the edge between vertex i and j may be defined as:

$${A}_{i j} = \frac{{ω}_{j \to i} + {ω}_{i \to j}}{2} \qquad ( Eq . 22 )$$

The greater the value of weight Aᵢⱼ, the stronger the two vertices i and j are connected. For example, two cell may be considered connected only if the weight of the connection edge exceeds a certain threshold level. The threshold level may be adjustable. In geohash encoding, the threshold level may vary at different geohash levels.

A community detection algorithm may be used to group or partition each node (geohash cell) of the graph into one or more different communities, such that the nodes within the same community are densely connected and the nodes belonging to different communities are sparsely connected. The quality of the partitions is often measured by a modularity of the partition. The modularity metric is one measure of the structure of graphs and is indicative of the strength of division of a graph into clusters (i.e., groups or communities). In particular, the modularity measures the strength of a community partition by taking into account the degree of distribution. Graphs with high modularity have dense connections between the nodes within clusters but sparse connections between nodes in different clusters. Modularity is often used as an optimizing parameter for detecting community structure in graphs. The modularity metric, Q, may be defined as:

$$Q = \frac{1}{2 m} {\sum }_{i , j} [ {A}_{ij} - \frac{{k}_{i} {k}_{j}}{2 m} ] δ ( {c}_{i} , {c}_{j} ) \qquad ( Eq . 23 )$$

where Aᵢⱼ may be defined as above, kᵢ=ΣⱼAᵢⱼ may be the sum of the weights of the edges attached to vertex i, c_{c} is the community to which vertex i is assigned, and m may be the average weight between two vertices. The average weight m between two vertices may be defined as:

m=½ΣᵢⱼAᵢⱼ (Eq. 24)

and δ(u, v) maybe an impulse defined as

$$δ ( u , v ) = \{ \begin{matrix}1 , if u = v \\ 0 , otherwise\end{matrix}$$

A larger value for Q indicates a good community structure.

Examples of community detection algorithms include K-means and hierarchical clustering methods compatible with partitional clustering. Other examples of community detection algorithms include modularity optimization methods including the Louvain method and variants. The Louvain method includes two phases that are repeated iteratively. Initially, each node in the graph is assigned to its own community. In the first phase, small communities may be found by optimizing modularity locally on all nodes. For example, for each node i, a change in modularity is calculated for removing i from its own community and moving it into the community of each neighbor j of i. The change in modularity (ΔQ) may be calculated in two steps: (1) removing i from its original community, and (2) inserting i to the community of j. The two equations are quite similar, and the equation for step (2) is:

$$Δ Q = [ \frac{{\sum }_{in} + 2 {k}_{i , in}}{2 m} - {( \frac{{\sum }_{t o t} + 2 {k}_{i}}{2 m} )}^{2} ] - [ \frac{{\sum }_{in}}{2 m} - {( \frac{{\sum }_{t o t}}{2 m} )}^{2} - {( \frac{{k}_{i}}{2 m} )}^{2} ] \qquad ( Eq . 25 )$$

where Σᵢₙ is sum of all the weights of the links inside the community i is moving into, Σₜₒₜ is the sum of all the weights of the links to nodes in the community i is moving into, kᵢ is the weighted degree of i, k_{i,in} is the sum of the weights of the links between i and other nodes in the community that i is moving into, and m is the sum of the weights of all links in the graph. When the modularity change value is calculated for all communities i is connected to, i is placed into the community that resulted in the greatest modularity increase. If no increase is possible, i remains in its original community. This process is applied repeatedly and sequentially to all nodes until no modularity increase can occur. The first phase ends when a local maximum of modularity is determined. In the second phase, all of the nodes in the same community are grouped and a new graph is generated where the nodes are the communities from the previous phase. Any links between nodes of the same community may be represented by self-loops on the new community node and links from multiple nodes in the same community to a node in a different community may be represented by weighted edges between communities. The second phase ends when a new graph is created and another iteration beginning with the first phase may be repeated.

Further examples of community detection algorithms include Customers Segmentation, Targeted Marketing, Recommendation Systems, Discovering Dynamics of Epidemic, Tumor and Tissue Segmentation, Identification of Criminal Groups.

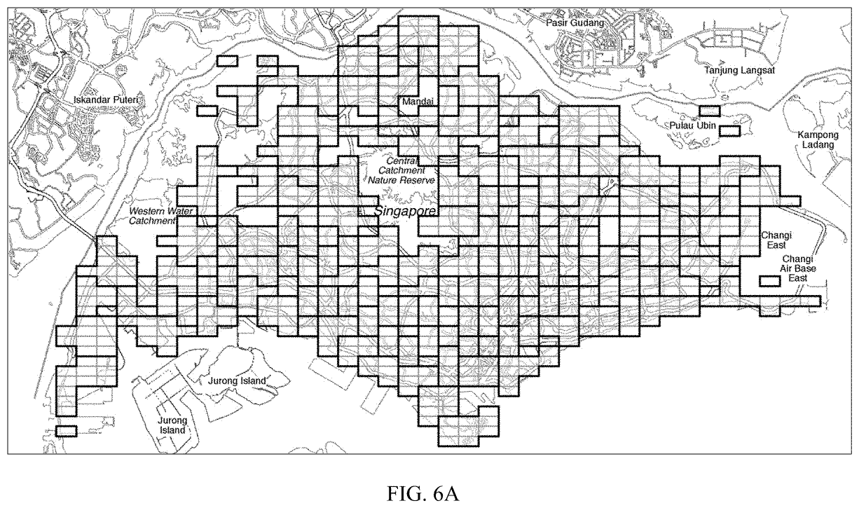

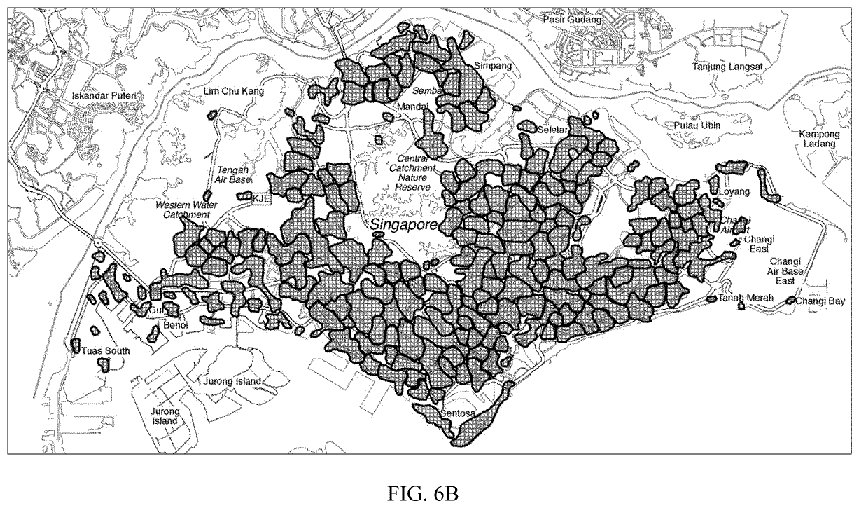

FIGS. 6A-6B illustrate determined clusters of geocoded cells over a map based on geocoded cells of different granularities (or sizes). FIG. 6A illustrates a map of Singapore that has been partitioned into a grid of geohash cells at level geohash 6 and where the geohash cells have been grouped into a plurality of communities based on supply and demand locations over an interval of time. The communities or clusters are shown in different shades of gray. FIG. 6B illustrates a map of Singapore that has been partitioned into a grid of geohash cells at level geohash 7 and where the geohash cells have been grouped into a plurality of communities based on supply and demand locations over another interval of time. The communities or clusters are shown in different shades of gray.

Additionally, when a driver located in one geographic cell declines a demand for pickup in another geohash cell, it may be considered as a factor that indicates that geographic cells are not related.

A connection strength between two geocoded cells may be determined based on a distance between the aggregate pick-up locations of the two geocoded cells over a period time. The aggregate pick-up location of a geocoded cell may be an average, mean, median, or mode of the pick-up locations of the booking demands in the geocoded cell. The distance may be a Euclidean distance, a routing distance, etc.

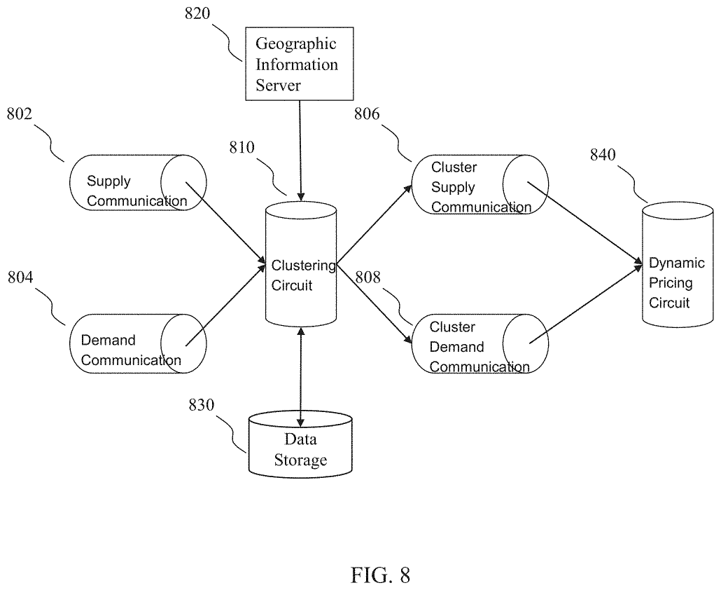

FIG. 8 illustrates a block diagram of a geographic partitioning system in accordance with various examples. The geographic partitioning system may be part of a ride-hailing matching system.

FIG. 8 is a system for determining groups of areas on a map having similar supply and demand patterns for dynamic pricing including a clustering circuit 810 and a dynamic pricing circuit 840. The clustering circuit 810 may be configured to partition a map into a grid of uniform geographic units (cells) and group one or more geographic units (cells) into an aggregate geographic unit (i.e., cluster). The clustering circuit 810 may group the one or more geographic units (cells) based on a connection metric between each two geographic units (cells).

The clustering circuit may be configured to receive demand communications 804 including location information of booking demands and supply communications 802 including location information of drivers when responding to booking demands.

The clustering circuit 810 may be configured to communicate with a data storage 830 to maintain supply and demand information and cluster information for different time periods. For example, data storage 830 may be configured to organize and store the received supply and demand location information based on a geocoded cell and a time period.

The clustering circuit 810 may be configured to communicate with a dynamic pricing circuit 840. The clustering circuit 810 may provide cluster supply communications 806 and cluster demand communications 808 to the dynamic pricing circuit. Each of the cluster supply and demand communications are related to a respective one of the one or more aggregate geographic units determined for a particular time period. The dynamic pricing circuit may be configured to determine a pricing for each respective aggregate geographic unit (cluster) of the particular time period.

The clustering circuit 810 may be configured to receive map information from a geographic information server 820. Alternatively, predetermined map information may be provided in data storage 830.

The clustering circuit 810 and/or dynamic pricing circuit may be implemented as one or more processors. The one or more processors may be part of a centralized system or a distributed system.

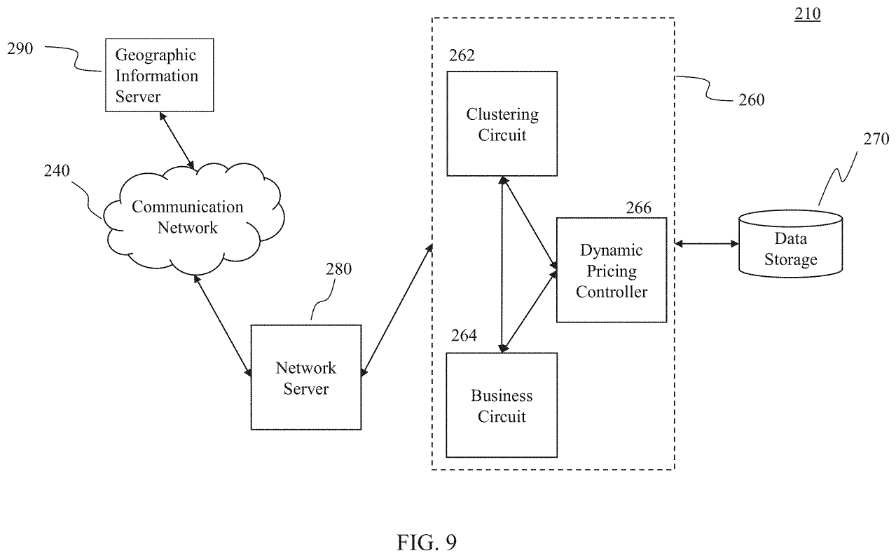

FIG. 9 illustrates a detailed block diagram of a ride-hailing system 210 in accordance with various examples. The ride-hailing system 210 may include an application server 260 for processing booking requests and responses, a database 270 for storing data, and a network server 280 for providing communication. The ride-hailing system 210 may also include a geographic information server 290 for providing map information.

Application server 260 may be implemented in a general computing device that communicates with database 270 and network server 280. For example, a general computing device may include one or more processors, one or more memory units, one or more mass storage, one or more input interfaces, and one or more output interfaces interconnected with one or more communication busses. One or more software applications or modules may be stored in one or more memory units and executable by one or more processors. The application server may include, for example, a business circuit 264, a clustering circuit 262, and dynamic pricing controller 266, implemented as one or more software modules on one or more processors that execute instructions stored in one or more memory mediums. The executed instructions may result in the processor(s) receiving and processing booking requests and booking responses, generating and providing results to the booking requests and booking responses, processing supply and demand information and generating partitioned maps, and providing dynamic pricing. For example, the business circuit 264 may match a booking request with a provider based on information provided by the clustering circuit 262 and the dynamic pricing controller 266. The application server may be implemented as a monolithic system or a decentralized system.

Database 270 may store booking request information (including request time information, pick-up location information, pick-up time information), booking response information (including response time information, response location information), route information, traffic data information, and other data for use with the ride-hailing service provided by application server 260. Database 270 may be separate from or integrated with application server 260. Database 270 may be a single database server or distributed among a plurality of database servers.

The network server 280 may provide the application server 260 access to a communications network 240. The network server 280 may be separate from or integrated with application server 260.

Various examples are provided.

Example 1 is a method for partitioning a geographic area including: partitioning the geographic area into geographic units; determining, for each respective geographic unit, a central location of the respective geographic unit; determining, for each respective geographic unit, an aggregate demand location of the respective geographic unit based on pick-up locations in the respective geographic unit in a time period; determining, for each respective geographic unit, an aggregate supply location of the respective geographic unit based on provider locations when responding to requests having pick-up locations in the respective geographic unit in said time period; determining, for each respective pair of geographic units among a plurality of the geographic units, a connection strength between the respective pair of geographic units based on distance metrics between the respective pair of geographic units, where the distance metrics are determined based on the central locations, the aggregate supply locations, and the aggregate demand locations of the respective pair of geographic units in said time period; and assigning each respective geographic unit to a respective one of one or more aggregate geographic units based on the determined connection strengths.

In Example 2, the method of Example 1, further includes: determining, for each respective pair of geographic units, a central distance, where the central distance is based on a distance between the central locations of the geographic units of the respective pair of geographic units in said time period.

In Example 3, the method of Example 2, where the central distance is the Euclidean distance between the geometric centers of the respective pair of geographic units.

In Example 4, the method of Example 2, further includes: determining, for each respective pair of geographic units having pick-up locations in said time period, a demand distance, where the demand distance is based on a distance between the aggregate demand locations of the geographic units of the respective pair of geographic units in said time period.

In Example 5, the method of Example 4, where the demand distance is the Euclidean distance between the aggregate demand locations of the respective pair of geographic units.

In Example 6, the method of Example 4, further includes: determining, for each respective pair of geographic units, a supply distance, where the supply distance is based on a distance between the aggregate supply locations of the geographic units of the respective pair of geographic units in said time period.

In Example 7, the method of Example 6, where the supply distance is the Euclidean distance between the aggregate supply locations of the respective pair of geographic units.

In Example 8, the method of Example 6, where the connection strength between two geographic units of the respective pair of geographic units is determined based on the central distance, the demand distance, and the supply distance between the two geographic units of the respective pair of geographic units.

In Example 9, the method of Example 8, where the aggregate demand location of the respective geographic unit is based on an average of the distribution of pick-up locations in the respective geographic unit in said time period.

In Example 10, the method of Example 8, where the aggregate supply location of the respective geographic unit based on an average of the distribution of provider locations when responding to requests having pick-up locations in the respective geographic unit in said time period.

In Example 11, the method of Example 8, where the connection strength between two geographic units of the respective pair of geographic units is directional and where the connection strength is determined in both directions.

In Example 12, the method of Example 8, where the connection metric is further determined based on a supply distance modifying factor.

In Example 13, the method of Example 12, where the supply distance modifying factor for the supply distance into a demand geographic unit from a supply geographic unit is based on a ratio of a total number of suppliers of the demand geographic unit and the number of suppliers of the demand geographic unit from the supply geographic unit.

In Example 14, the method of Example 8, where assigning each respective geographic unit to a respective one of one or more aggregate geographic units based on the determined connection strengths, includes: assigning a first geographic unit to a first aggregate geographic unit; and assigning a second geographic unit to said first geographic unit when the connection strength between the first geographic unit and the second geographic unit exceeds a predetermined threshold.

In Example 15, the method of Example 8, where assigning each respective geographic unit to a respective one of one or more aggregate geographic units based on the determined connection strengths, includes: determining a first modularity metric of a geographic unit based on said geographic unit being assigned to a first aggregate geographic unit; determining a second modularity metric of said geographic unit based on said geographic unit being assigned to a second aggregate geographic unit; assigning said geographic unit to the first aggregate geographic unit when the first modularity metric of said geographic unit is larger than the second modularity metric of said geographic unit.

In Example 16, the method of Example 8, further includes: determining, for each respective aggregate geographic unit, a cluster demand location, where the cluster demand location is determined based on an average of the aggregate demand locations of all geographic units assigned to the respective aggregate geographic unit; and determining, for each respective aggregate geographic unit, a cluster supply location, where the cluster supply location is determined based on an average of the aggregate demand locations of all geographic units assigned to the respective aggregate geographic unit.

In Example 17, the method of Example 16, further includes: assigning, to each respective geographic unit of the respective aggregate geographic unit, the cluster demand location and the cluster supply location of the respective aggregate geographic unit; and determining a pricing based on the respective cluster demand location and cluster supply location.

Example 18 is a method for partitioning a geographic area including: partitioning the geographic area into a grid of uniform geographic units; determining a central location of at least one of the geographic units; receiving information related to pick-up locations and provider locations in the geographic area associated with a time period; determining an aggregate demand location of said at least one of the geographic units based on the distribution of pick-up locations in said at least one of the respective geographic units in said time period; determining an aggregate supply location of said at least one of the geographic units based on the distribution of provider locations when responding to requests having pick-up locations in said at least one of the geographic units in said time period; determining a connection metric between two geographic units of said at least one of the geographic units, wherein the connection metric is based on a central distance, a demand distance, and a supply distance, wherein the central distance is a distance between the central locations, the demand distance is a distance between the aggregate supply locations, and the supply distance is a distance between the aggregate demand locations of the two geographic units in said time period; and assigning said at least one of the geographic units to an aggregate geographic unit based on the connection metric.

Example 19 is a method for partitioning a geographic area including: receiving information related to pick-up locations and provider locations in the geographic area associated with a time period; partitioning the geographic area into a uniform set of geocoded cells; determining, for each respective geocoded cell of the set, a central location of the respective geocoded cell; determining, for each respective geocoded cell of the set, an aggregate demand location of the respective geocoded cell based on pick-up locations in the respective geocoded cell in said time period; determining, for each respective geocoded cell of the set, an aggregate supply location of the respective geocoded cell based on provider locations when responding to requests having pick-up locations in the respective geocoded cell in said time period; determining, for each respective pair of geocoded cells among a subset of the geocoded cells, a connection strength between the respective pair of geocoded cells based on distance metrics between the respective pair of geocoded cells, wherein the distance metrics are determined based on a distance between the central locations of the respective pair of geocoded cells, a distance between the aggregate supply locations of the respective pair of geocoded cells in said time period, and a distance between the aggregate demand locations of the respective pair of geocoded cells in said time period; and assigning each respective geocoded cell to a respective one of one or more clusters based on the determined connection strengths.

In Example 20, the method of Example 19, where the subset of the geocoded cells includes a plurality of geocoded cells, where the distance between the central locations of each of the plurality of geocoded cells is less than a predetermined maximum distance or where the number of hops between each of the plurality of geocoded cells is fewer than a predetermined maximum number of hops.

In another Example 20, the method of Example 1, where the plurality of the geographic units is a subset of geographic units where the distance between the central locations of each of the plurality of geographic units is less than a predetermined maximum distance or where the number of hops between each of the plurality of geographic units is fewer than a predetermined maximum number of hops.

Example 21 is, a method for partitioning a geographic area including: partitioning the geographic area into geographic units; determining, for each geographic unit, a central location of the geographic unit; determining, for each geographic unit, an aggregate demand location of the respective geographic unit based on the distribution of pick-up locations in the respective geographic unit in a time period; determining, for each geographic unit, an aggregate supply location of the respective geographic unit based on the distribution of provider locations when responding to requests having pick-up locations in the respective geographic unit in the time period; determining a connection metric between two geographic units based on distance metrics, where the distance metrics are determined based on the central locations, the aggregate supply locations, and the aggregate demand locations of the two geographic units in the time period; and assigning the geographic units into one or more aggregate geographic units based on the connection metric.

In Example 22, the method of Example 21 may further include determining, for each respective pair of geographic units, a central distance, where the central distance is based on a distance between the central locations of the geographic units of the respective pair of geographic units in the time period.

In Example 23, the method of Examples 21 or 22, may further include determining, for each respective pair of geographic units having pick-up locations in the time period, a demand distance, where the demand distance is based on a distance between the aggregate demand locations of the geographic units of the respective pair of geographic units in the time period.

In Example 24, the method of any one of Examples 21 to 23, may further include determining, for each respective pair of geographic units, a supply distance, where the supply distance is based on a distance between the aggregate supply locations of the geographic units of the respective pair of geographic units in the time period.

In Example 25, the method of any one of Examples 21 to 24, may further include, where the connection metric between two geographic units is determined based on the central distance, the demand distance, and the supply distance between the two geographic units.

In Example 26, the method of Example 22, may further include where the central distance is the Euclidean distance between the geometric centers of the respective pair of geographic units.

In Example 27, the method of Example 23 may further include where the demand distance is the Euclidean distance between the aggregate demand locations of the respective pair of geographic units.

In Example 28, the method of Example 24, may further include, where the supply distance is the Euclidean distance between the aggregate supply locations of the respective pair of geographic units.

In Example 29, the method of Example 25, may further include where the connection metric is further determined based on a supply distance modifying factor.

In Example 30, the method of Example 29, may further include where the supply distance modifying factor for the supply distance into a demand geographic unit from a supply geographic unit is based on a ratio of a total number of suppliers of the demand geographic unit and the number of suppliers of the demand geographic unit from the supply geographic unit.

In Example 31, the method of Example 24, may further include receiving information providing pick-up locations and pick-up times of a plurality of requests.

In Example 32, the method of Example 31, may further include receiving information providing provider locations associated to when providers respond to the plurality of requests.

In Example 33, the method of Example 32, may further include where a provider's response is an acceptance or rejection of a request.

In Example 34, the method of Example 32, may further include where a provider's response is only an acceptance of a request.

While the disclosure has been particularly shown and described with reference to specific examples, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for partitioning a geographic area comprising:
partitioning the geographic area into geographic units;
determining, for each respective geographic unit, a central location of the respective geographic unit;
determining, for each respective geographic unit, an aggregate demand location of the respective geographic unit based on pick-up locations in the respective geographic unit in a time period;
determining, for each respective geographic unit, an aggregate supply location of the respective geographic unit based on provider locations when responding to requests having pick-up locations in the respective geographic unit in said time period;
determining, for each respective pair of geographic units among a plurality of the geographic units, a connection strength between the respective pair of geographic units based on distance metrics between the respective pair of geographic units, wherein the distance metrics are determined based on the central locations, the aggregate supply locations, and the aggregate demand locations of the respective pair of geographic units in said time period; and
assigning each respective geographic unit to a respective one of one or more aggregate geographic units based on the determined connection strengths.

2. The method of claim 1, further comprising:
determining, for each respective pair of geographic units, a central distance, wherein the central distance is based on a distance between the central locations of the geographic units of the respective pair of geographic units in said time period.

3. The method of claim 2, wherein the central distance is the Euclidean distance between the geometric centers of the respective pair of geographic units.

4. The method of claim 2, further comprising:
determining, for each respective pair of geographic units having pick-up locations in said time period, a demand distance, wherein the demand distance is based on a distance between the aggregate demand locations of the geographic units of the respective pair of geographic units in said time period.

5. The method of claim 4, wherein the demand distance is the Euclidean distance between the aggregate demand locations of the respective pair of geographic units.

6. The method of claim 4, further comprising:
determining, for each respective pair of geographic units, a supply distance, wherein the supply distance is based on a distance between the aggregate supply locations of the geographic units of the respective pair of geographic units in said time period.

7. The method of claim 6, wherein the supply distance is the Euclidean distance between the aggregate supply locations of the respective pair of geographic units.

8. The method of claim 6, wherein the connection strength between two geographic units of the respective pair of geographic units is determined based on the central distance, the demand distance, and the supply distance between the two geographic units of the respective pair of geographic units.

9. The method of claim 8, wherein the aggregate demand location of the respective geographic unit is based on an average of the distribution of pick-up locations in the respective geographic unit in said time period.

10. The method of claim 8, wherein the aggregate supply location of the respective geographic unit based on an average of the distribution of provider locations when responding to requests having pick-up locations in the respective geographic unit in said time period.

11. The method of claim 8, wherein the connection strength between two geographic units of the respective pair of geographic units is directional and wherein the connection strength is determined in both directions.

12. The method of claim 8, wherein the connection metric is further determined based on a supply distance modifying factor.

13. The method of claim 12, wherein the supply distance modifying factor for the supply distance into a demand geographic unit from a supply geographic unit is based on a ratio of a total number of suppliers of the demand geographic unit and the number of suppliers of the demand geographic unit from the supply geographic unit.

14. The method of claim 8, wherein assigning each respective geographic unit to a respective one of one or more aggregate geographic units based on the determined connection strengths, comprises:
assigning a first geographic unit to a first aggregate geographic unit; and
assigning a second geographic unit to said first geographic unit when the connection strength between the first geographic unit and the second geographic unit exceeds a predetermined threshold.

15. The method of claim 8, wherein assigning each respective geographic unit to a respective one of one or more aggregate geographic units based on the determined connection strengths, comprises:
determining a first modularity metric of a geographic unit based on said geographic unit being assigned to a first aggregate geographic unit;
determining a second modularity metric of said geographic unit based on said geographic unit being assigned to a second aggregate geographic unit;
assigning said geographic unit to the first aggregate geographic unit when the first modularity metric of said geographic unit is larger than the second modularity metric of said geographic unit.

16. The method of claim 8, further comprising:
determining, for each respective aggregate geographic unit, a cluster demand location, wherein the cluster demand location is determined based on an average of the aggregate demand locations of all geographic units assigned to the respective aggregate geographic unit; and
determining, for each respective aggregate geographic unit, a cluster supply location, wherein the cluster supply location is determined based on an average of the aggregate demand locations of all geographic units assigned to the respective aggregate geographic unit.

17. The method of claim 16, further comprising:
assigning, to each respective geographic unit of the respective aggregate geographic unit, the cluster demand location and the cluster supply location of the respective aggregate geographic unit; and
determining a pricing associated with the respective geographic unit in said time period based on the respective cluster demand location and cluster supply location.

18. A method for partitioning a geographic area comprising:
partitioning the geographic area into a grid of uniform geographic units;
determining a central location of at least one of the geographic units;
receiving information related to pick-up locations and provider locations in the geographic area associated with a time period;
determining an aggregate demand location of said at least one of the geographic units based on the distribution of pick-up locations in said at least one of the respective geographic units in said time period;
determining an aggregate supply location of said at least one of the geographic units based on the distribution of provider locations when responding to requests having pick-up locations in said at least one of the geographic units in said time period;
determining a connection metric between two geographic units of said at least one of the geographic units, wherein the connection metric is based on a central distance, a demand distance, and a supply distance, wherein the central distance is a distance between the central locations, the demand distance is a distance between the aggregate supply locations, and the supply distance is a distance between the aggregate demand locations of the two geographic units in said time period; and
assigning said at least one of the geographic units to an aggregate geographic unit based on the connection metric.

19. A method for partitioning a geographic area comprising:
receiving information related to pick-up locations and provider locations in the geographic area associated with a time period;
partitioning the geographic area into a uniform set of geocoded cells;
determining, for each respective geocoded cell of the set, a central location of the respective geocoded cell;
determining, for each respective geocoded cell of the set, an aggregate demand location of the respective geocoded cell based on pick-up locations in the respective geocoded cell in said time period;
determining, for each respective geocoded cell of the set, an aggregate supply location of the respective geocoded cell based on provider locations when responding to requests having pick-up locations in the respective geocoded cell in said time period;
determining, for each respective pair of geocoded cells among a subset of the geocoded cells, a connection strength between the respective pair of geocoded cells based on distance metrics between the respective pair of geocoded cells, wherein the distance metrics are determined based on a distance between the central locations of the respective pair of geocoded cells, a distance between the aggregate supply locations of the respective pair of geocoded cells in said time period, and a distance between the aggregate demand locations of the respective pair of geocoded cells in said time period; and
assigning each respective geocoded cell to a respective one of one or more clusters based on the determined connection strengths.

20. The method of claim 19, wherein the subset of the geocoded cells comprises a plurality of geocoded cells, wherein the distance between the central locations of each of the plurality of geocoded cells is less than a predetermined maximum distance or wherein the number of hops between each of the plurality of geocoded cells is fewer than a predetermined maximum number of hops.
